(19) United States
(12) Patent Application Publication
(10) Pub. No.: US 2006/0022638 A1
(43) Pub. Date: Feb. 2, 2006

(54) [MULTIFUNCTIONAL BATTERY CHARGER]

(75) Inventors: Chun-Chung Lai, TAIPEI (TW); Man-Lung Hu, TAIPEI (TW)

Correspondence Address: AKKU POWER LIMITED COMPANY, 2F-4, NO. 148, SEC. 4, CHUNG HSIAO EAST ROAD, TAIPEI, TW

(73) Assignee: AKKU POWER ELECTRONIC CO., LTD., NEI-HU DISTRICT, TAIPEI CITY (TW)

(21) Appl. No.: 10/710,728

(22) Filed: Jul. 30, 2004

(51) Int. Cl. H02J 7/00

(52) U.S. Cl. 320/116

(57) ABSTRACT

A multifunctional battery charger, capable of charging both lithium battery and nickel-metal hydride battery, and a method of charging battery using the multifunctional battery charger are provided. The multifunctional battery charger comprises a slot, for receiving a battery to be charged, wherein the battery is a lithium battery or a nickel-metal hydride battery; a microcontroller, comprising an identifying module and a charging module, wherein the identifying module is adapted for identifying a specification of the battery; a pulse width modulator, for charging the battery, wherein the pulse width modulator and the slot are connected to the microcontroller, and wherein the charging module of the microcontroller is adapted for controlling the pulse width modulator for charging said battery.

### BACKGROUND OF INVENTION

1. The Field of the Invention

The present invention relates to a multifunctional battery charger, and more particularly, to a multifunctional battery charger capable of charging batteries of various specifications.

2. Description of Related Art

The advancement of technologies has substantially improved our everyday life style for better. The working style has changed drastically since the notebook computer and mobile phone are available on the market. These electronic appliances are popular for being portable, as the user can use them anytime and anywhere to obtain the latest information. The above electronic appliances are operated with battery power, and for extending the usage period, the manufacturers have improved the battery from a disposable battery type in the early stage to a widely used chargeable battery. This development has reduced the power consumption cost as the battery can be recharged for several times.

Presently, the available chargeable batteries are commonly lithium battery and the nickel-metal hydride battery, and due to the different characteristics of these two types of batteries, the designs of the battery chargers are accordingly different. Referring to FIG. 6, a curve showing a relationship of voltage and current with charging time of a lithium battery is shown. The conventional lithium battery is charged using the constant voltage, and the current flowing into the lithium battery reduces gradually according to the gradual saturation of the power volume in the battery. When the current reduces to the preset level, the charging of the battery is determined to be complete. Referring to FIG. 7, a curve showing a relationship of voltage and current with charging time of a nickel-metal hydride battery is shown. The conventional nickel-metal hydride battery is charged using the constant current, and the current flowing into the nickel-metal hydride battery reduces gradually according to the gradual saturation of the power volume in the battery, shown as the sector A and B in FIG. 7. When the battery is charged to the saturated level, the negative delta voltage (−ΔV) of the nickel-metal hydride battery occurs and the current rises again, as shown as the sector C in FIG. 7. Therefore, the nickel-metal hydride battery needs to have the sensor for sensing the negative delta voltage (−ΔV) to avoid overcharging of the battery which could damage the battery or cause fire accidents.

However, the chemical characteristics of the lithium battery and nickel-metal hydride battery are different, the manufacturers have to design and manufacture two different battery chargers according. Accordingly, inventory/warehousing and manufacturing cost are increased.

Because the available lithium battery and nickel-metal hydride battery are widely used nowadays, the user usually buy several types of chargeable batteries, and if the user mistakenly uses a wrong battery charger for charging the battery, not only the battery gets damaged but also this may cause fire accidents causing property and or life damage.

The above defects of the conventional battery charger are important issues for the manufacturers in the field to improve.

### SUMMARY OF INVENTION

Accordingly, in the view of the foregoing, the present inventor makes a detailed study of related art to evaluate and consider, and uses years of accumulated experience in this field, and through several experiments, to create a new multifunctional battery charger. The present invention provides an innovated cost effective multifunctional battery charger capable of charging batteries of various specifications.

According to an aspect of the present invention, the chemical characteristics is determined for sensing the battery type in the multifunctional battery charger and charge the battery according to its specification. Therefore, charging the battery with wrong specification can be effectively avoided and thus damage to the battery and fire accident due to wrong operation can be effectively avoided.

According to another aspect of the present invention, the multifunctional battery charger comprises a microcontroller for identifying the battery types. The microcontroller comprises a plurality of charging modules for charging according to various chemical characteristics. Accordingly, the battery charger according to an embodiment of the present invention is capable of providing multifunction, thus requirement of a battery charger for a particular battery type can be avoided. Thus, the inventory of different types of battery chargers for different battery types and warehousing/stocking thereof can be effectively avoided. Therefore, the overall cost can be effectively reduced.

### BRIEF DESCRIPTION OF DRAWINGS

For a more complete understanding of the present invention, reference will now be made to the following detailed description of preferred embodiments taken in conjunction with the following accompanying drawings.

FIG. 1 is a block diagram of a multifunctional battery charger according to an embodiment of the present invention.

FIG. 1A is a circuit layout (1) of a multifunctional battery charger according to an embodiment of the present invention.

FIG. 1B is a circuit layout (2) of a multifunctional battery charger according to an embodiment of the present invention.

FIG. 2 is an elevational view of a multifunctional battery charger according to an embodiment of the present invention.

FIG. 3 is a flowchart showing a method of charging a battery using the multifunctional battery charger according to an embodiment of the present invention.

FIG. 4 is a circuit layout (1) of a multifunctional battery charger according to another embodiment of the present invention.

FIG. 4A is a circuit layout (2) of a multifunctional battery charger according to another embodiment of the present invention.

FIG. 5 is an elevational view of a multifunctional battery charger according to another embodiment of the present invention.

FIG. 6 is a curve showing a relationship of voltage and current with charging time of a lithium battery.

FIG. 7 is a curve showing a relationship of voltage and current with charging time of a nickel-metal hydride battery.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

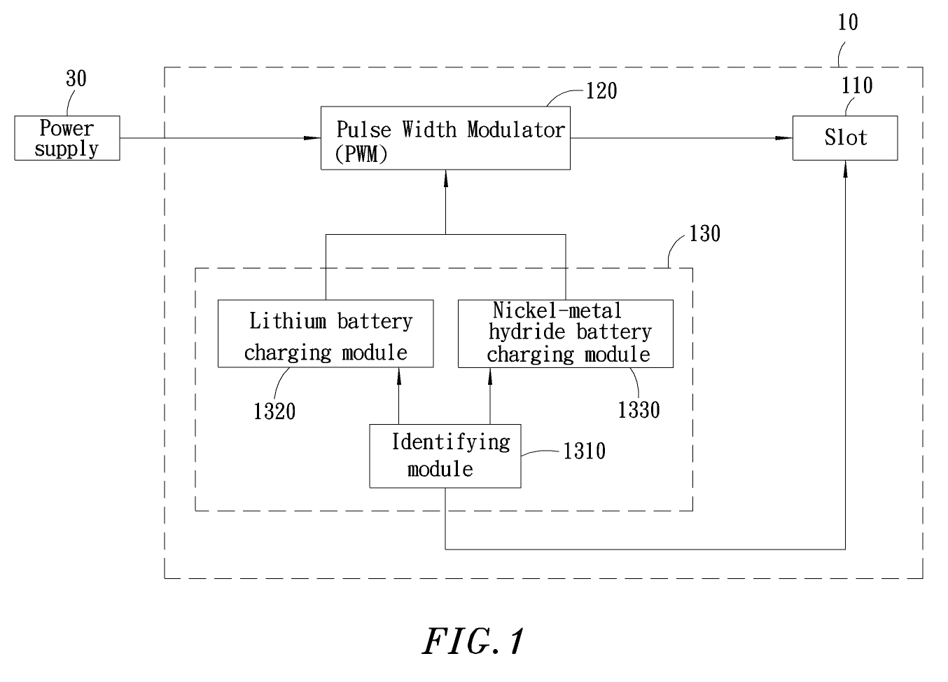

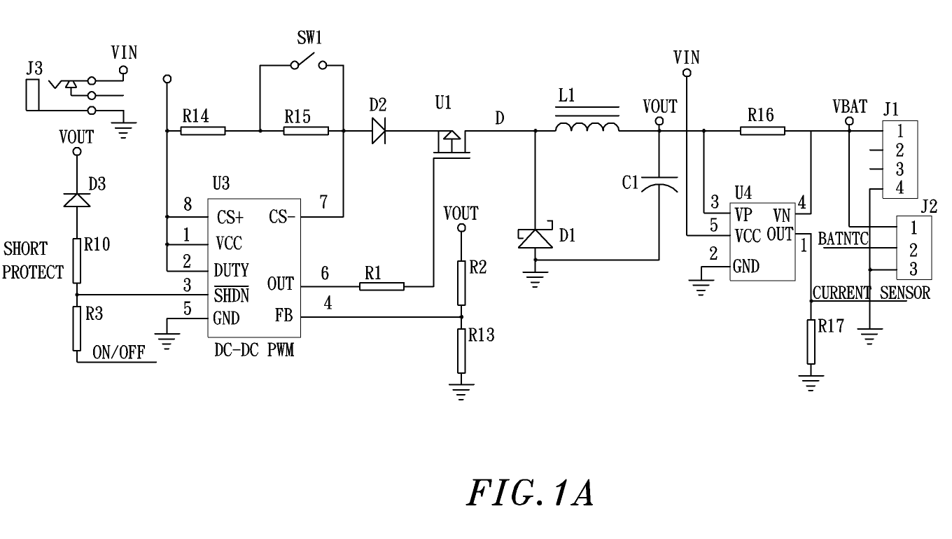

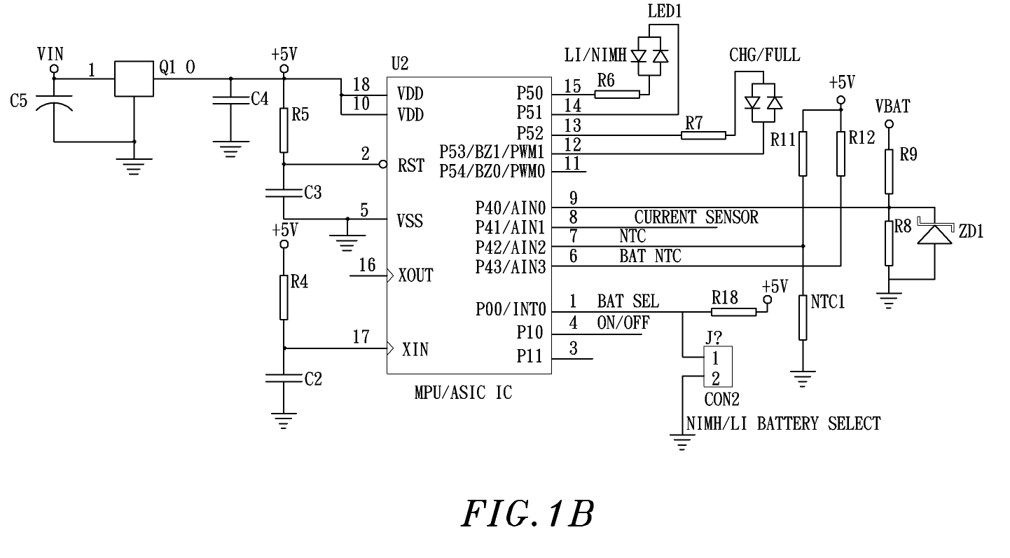

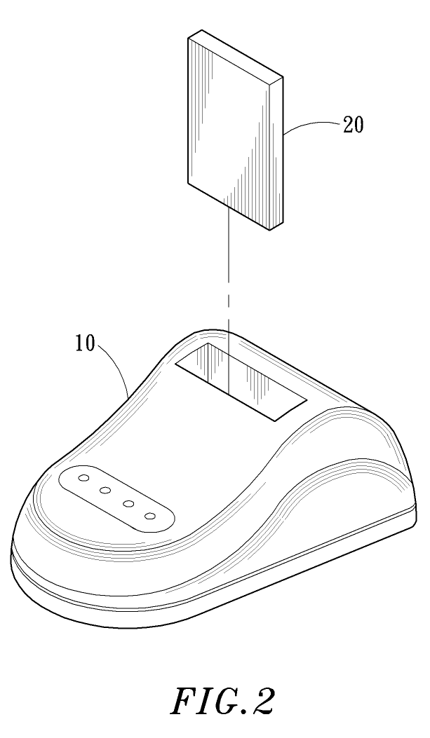

Referring to FIGS. 1, 1A, 1B and 2, the multifunctional battery charger 10, according to an embodiment of the present invention, comprises a slot 110 and a pulse width modulator (PWM) 120 and the microcontroller 130.

Batteries 20 with various chemical characteristics can be inserted into the slot 110.

The PWM 120 is connected to the slot 110 and a power supply 30. The power supply 30 can supply direct current for charging the battery 20 inserted in the slot 110.

The microcontroller 130 is connected to the slot 110 and the PWM 120. The microcontroller 130 comprises an identifying module 1310, a lithium battery charging module 1320 and a nickel-metal hydride battery charging module 1330.

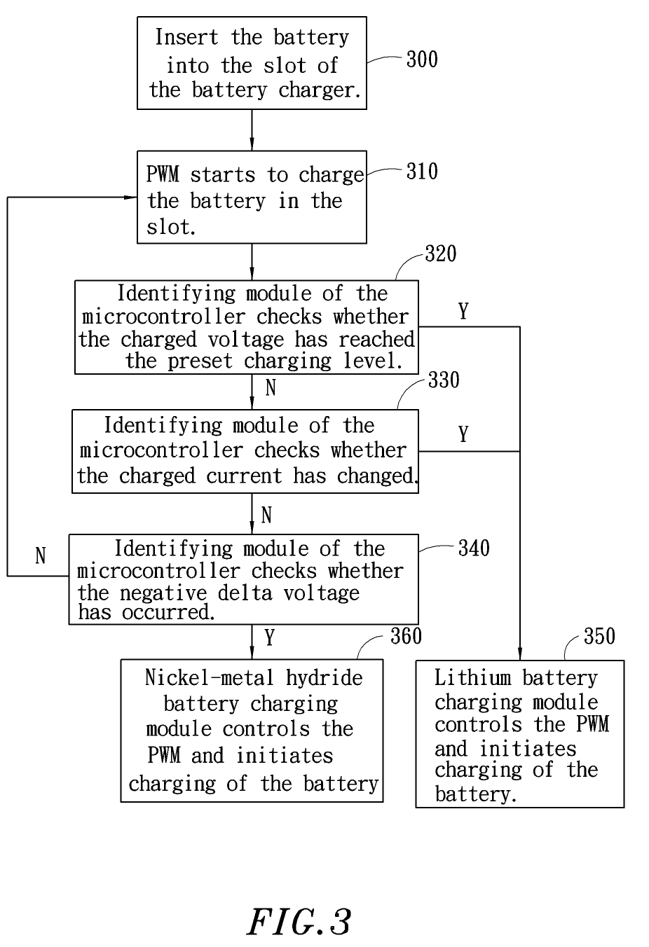

The procedure of charging the battery 20 inserted in the slot 110 of the multifunctional battery charger 10 is described in detail with reference to FIGS. 1, 2 and 3 as follows.
at step 300, the battery 20 is inserted into the slot 110 of the multifunctional battery charger 10;
at step 310, the pulse width modulator 120 starts to charge the battery 20 in the slot 110;
at step 320, the identifying module 1310 of the microcontroller 130 checks whether the charged voltage has reached the preset charging level, if yes, the procedure proceeds to step 350, if not, then the procedure proceeds to step 330;
at step 330, the identifying module 1310 of the microcontroller 130 checks whether the charged current has changed, if yes, the procedure proceeds to step 350, if not, the procedure proceeds to step 340;
at step 340, the identifying module 1310 of the microcontroller 130 checks whether the negative delta voltage (−ΔV) has occurred, if yes, the procedure proceeds to step 360, if not, the procedure proceeds to step 310;
at step 350, the lithium battery charging module 1320 controls the PWM 120 and initiates charging of the battery 20; and
at step 360, the nickel-metal hydride battery charging module 1330 controls the PWM 120 and initiates charging of the battery 20.

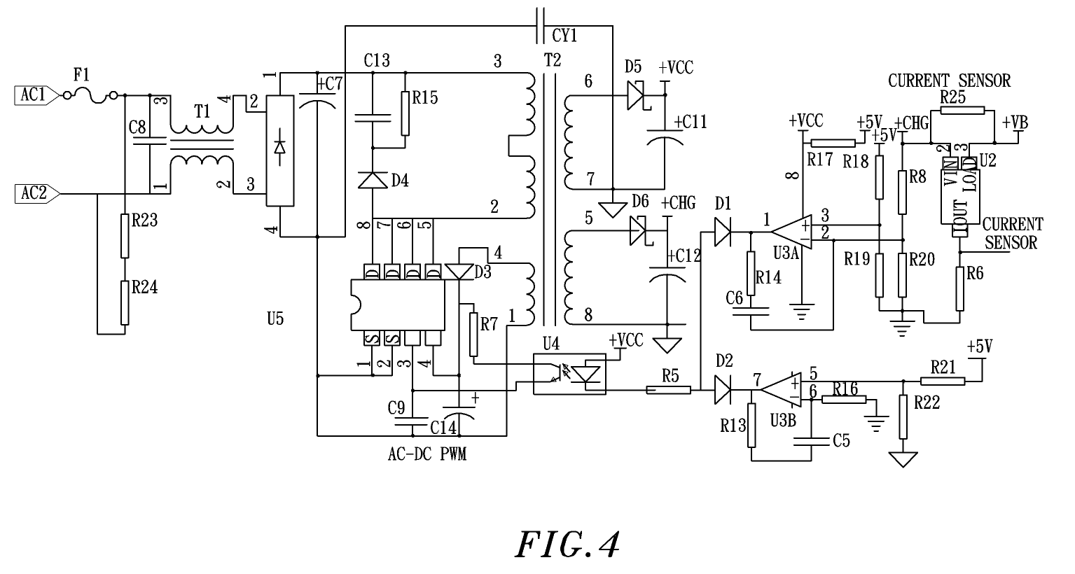

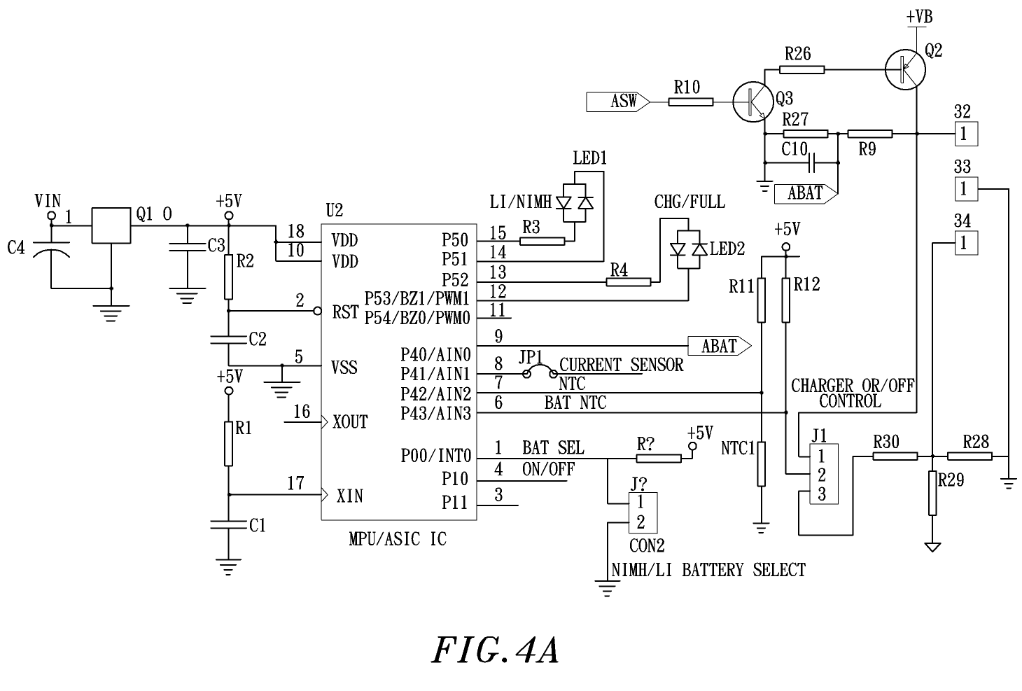

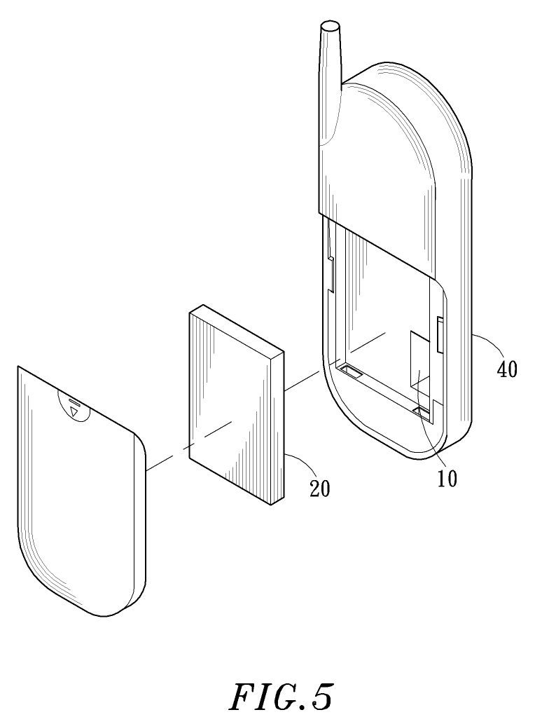

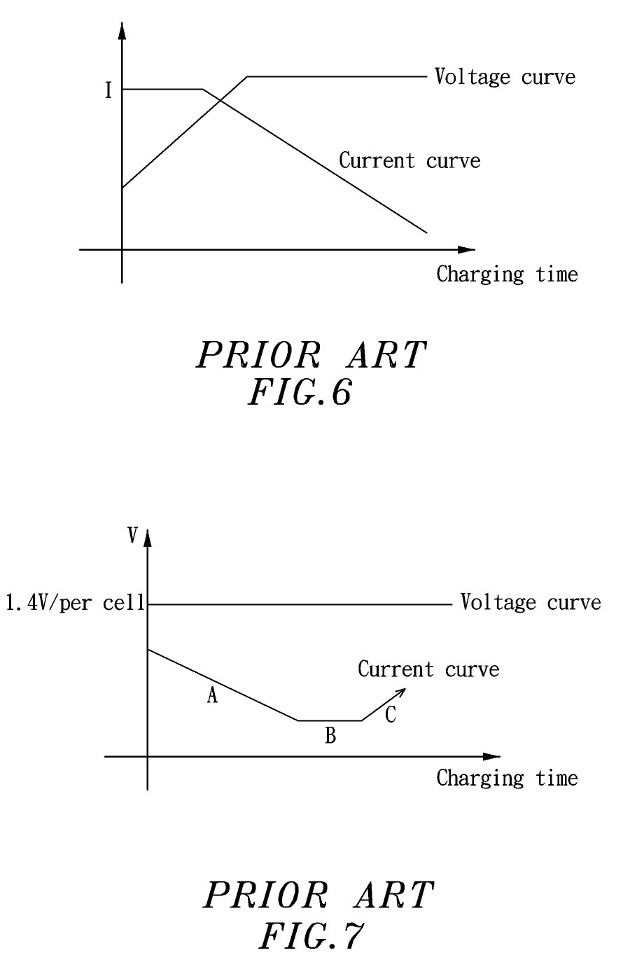

Referring to FIGS. 4 and 4A, the power supply 30 connected to the PWM 120 can supply an alternative current for charging the battery 20 inserted in the slot 110.

Referring to FIG. 5, the multifunctional battery charger 10, according to an embodiment of the present invention, can be installed in an electronic appliance 40 to provide portable battery charger function.

Furthermore, the identifying module 1310, according to an embodiment of the present invention, can be a maximum protection voltage circuit (MPV) or the application specific integrated circuit (ASIC).

According to an embodiment of the present invention, the multifunctional battery charger 10 comprises the microcontroller 130 having the identifying module 1310 for identifying the specification of the battery 20 in the slot 110, the lithium battery charging module 1320 and the nickel-metal hydride battery charging module 1330. The lithium battery charging module 1320 is utilized for charging the lithium battery and the nickel-metal hydride battery charging module 1330 is utilized for charging the nickel-metal hydride battery. Therefore, charging the battery with the wrong specification can be effectively avoided and thus damage to the battery or fire accident due to wrong charging operation can be effectively avoided. Additionally, a single production line is required for producing the multifunctional battery charger of the present invention, thus, capital investment, warehousing and manufacturing cost can be effectively reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. A multifunctional battery charger, capable of charging both lithium battery and nickel-metal hydride battery, comprising:
a slot, for receiving a battery to be charged, wherein said battery is a lithium battery or a nickel-metal hydride battery;
a microcontroller, comprising an identifying module and a charging module, wherein said identifying module is adapted for identifying a specification of said battery in said slot; and
a pulse width modulator, for charging said battery in said slot, said pulse width modulator and said slot connected to said microcontroller, wherein said charging module of said microcontroller is adapted for controlling said pulse width modulator for charging said battery.

2. The multifunctional battery charger according to claim 1, wherein said pulse width modulator is connected to a power suppler.

3. The multifunctional battery charger according to claim 1, wherein said identifying module comprises a maximum protected voltage circuit (MPV).

4. The multifunctional battery charger according to claim 1, wherein said identifying module comprises an application specific integrated circuit (ASIC).

5. A method of charging a battery using a multifunctional battery charger, comprising:
(a) inserting a battery into a slot of said multifunctional battery charger;
(b) using a pulse width modulator to charge said battery in said slot;
(c) using an identifying module of a microcontroller to check whether a charged voltage has reached a preset charging level, wherein if the charged voltage has not reached to the preset charging level, the method proceeds to step (d);
(d) using said identifying module of said microcontroller to check whether a charged current has changed, wherein if the charged current has not changed, the method proceeds to step (e);
(e) using said identifying module of said microcontroller to check whether a negative delta voltage (−ΔV) has occurred, wherein if the negative delta voltage (−ΔV) has occurred, the method proceeds to step (f); and
(f) using a nickel-metal hydride battery charging module to control said pulse width modulator for charging said battery.

6. The method of charging a battery using a multifunctional battery charger according to claim 5, wherein if the charged voltage has reached to the preset charging level, the method proceeds to step (g), wherein a lithium battery charging module is used to control said pulse width modulator for charging said battery.

7. The method of charging a battery using a multifunctional battery charger according to claim 5, wherein if the charged current has changed, the method proceeds to step (g), wherein a lithium battery charging module is used to control said pulse width modulator for charging said battery.
